(19) United States
(12) Patent Application Publication
(10) Pub. No.: US 2007/0010971 A1
(43) Pub. Date: Jan. 11, 2007

(54) Method of automatically transferring router functionality

(75) Inventors: Mariana Vassileva Nikolova, Eindhoven (NL); Xuemei Pu, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,604

(22) PCT Filed: Dec. 7, 2004
(86) PCT No.: PCT/IB04/52681

§ 371 Date: Jun. 19, 2006

(30) Foreign Application Priority Data
Dec. 22, 2003 (EP) 03104910.9

(51) Int. Cl. G06F 11/00

(52) U.S. Cl. 702/188

(57) ABSTRACT

There is provided a heterogeneous communication network (10) preferably conforming to contemporary IPv4-/IPv6-standards. The network (10) includes several interconnected nodes including one or more candidate devices (100, 110, 130). Moreover, some of the nodes are operable as data routers (60, 100, 110). The present invention provides a method for dynamically organizing operation of the routers including using the candidate devices (100, 110) to undertake routing functions where existing routing nodes become inoperable. Moreover, the method utilizes link local router advertisements for the nodes to make their presence known within the network (10). Furthermore, the network (10) employs a watcher to be an arbiter of which of the nodes are permitted to function as routers, and the nodes are arranged to communicate with the watcher if a discrepancy and/or conflict in assignment of router arises during operation. Use of the watcher enables the network (10) to be more robust on account of its routers being dynamically reconfigurable.

The present invention relates to methods of transferring router functionality; in particular, but not exclusively, the invention relates to routers employed for constructing communication networks, for example the Internet. Moreover, the present invention also relates to routers functioning according to the method. Furthermore, the invention also relates to communication networks including such routers.

Communication networks, for example the Internet, include a multiplicity of interconnected communication nodes. Moreover, these networks are operable to facilitate the communication of data content therein. Such communication of data content requires reliable data routing between the nodes and hence a certain degree of mutual compatibility within the networks. Thus, the networks utilize routers which are operable to route blocks of data content in a controlled manner between the nodes.

It is known that the aforementioned communication networks are susceptible to node changes therein, for example changes arising from connection of new nodes and nodal failures caused by one or more of plug-out, power disruption, unexpected functional failure and temporary unavailability. Plug-out potentially arises when a node becomes disconnected. Power disruption occurs when electrical supply to a node is interrupted or exhausted. Unexpected nodal functional failure can arise due to component parts developing electronic faults. Temporary nodal unavailability can arise, for example, because logic gates switch to an unintended state or a processor is caught in an endless software loop. The more complex a communication network becomes, the more likely that at least a part of the network is non-functional at any given instance and/or subject to change. In order to be able to cope with such change and/or non-functionality, it is known to provide routers for communication networks, the routers being re-configurable to cope with communication network changes and/or partial failures.

For example, in a published European patent application no. EP 1,011,231, there is described a method and apparatus providing for router redundancy of non-Internet protocols using a virtual router redundancy protocol. The patent application concerns one or more communication network nodes configured with data communication protocol software suites other than TCP/IP, and for which a default router election protocol such as VRRP is not available. TCP/IP is an abbreviation for “Transport Control Protocol/Internet Protocol”. Moreover, VRRP is an abbreviation for “Virtual Router Redundancy Protocol”, for example as set forth in the Internet Society's “Request for Comments” (RFC) 2338 in April 1998 and corresponds to an election protocol that assigns responsibility to a master virtual router. VRRP provides for dynamic fail-over in forwarding responsibility if a master virtual router becomes unavailable. As described in the patent application, the aforesaid one or more nodes are operable to forward non-TCP/IP traffic destined to nodes on other networks to the VRRP master virtual router. A non-TCP/IP based node, given a statically configured network layer address for a next hop router, resolves the network layer address to VRRP-based MAC layer address for the next hop router, if the next hop router has been VRRP enabled and is the master virtual router for TCP/IP traffic. The non-TCP/IP node caches the VRRP-based MAC address for use in forwarding non-TCP/IP traffic to an available next hop router. Thereafter, the non-TCP/IP node forwards traffic destined to nodes on other networks to the VRRP master virtual router. If the master virtual router becomes unavailable to forward TCP/IP based traffic, it transitions to become the new backup virtual router, while the backup virtual router transitions to become the new master virtual router responsible for forwarding TCP/IP based traffic. The new master virtual router shares the same VRRP based MAC address. Therefore, the non-TCP/IP based node, having cached the VRRP based MAC address of the next hop router, forwards traffic destined to nodes on other networks to the new master virtual router. This removes the need for intervention or reconfiguration of the non-TCP/IP based node for continued routing of non-TCP/IP traffic transmitted therefrom in the event that the router identified by the statically configured network layer address for a next hop router becomes unavailable.

The inventors have appreciated that contemporary communication networks, for example the Internet, employ routers conforming to a multiplicity of different data structure standards. For example, with regard to the Internet, it is known to employ routers conforming to a known Internet protocol standard IPv4. The IPv4-standard as defined in a document RFC 741 was adopted in 1981. It has served the Internet community well with virtually no change for over a period of 20 years. Moreover, the IPv4-standard has outlived subsequent OSI protocols intended to replace it. However, the IPv4-standard suffers a primary shortcoming with regard to its address space which is inadequate for data which is substantially all in Internet protocol. Consequently, a more advanced Internet protocol standard IPv6 as defined in a document RFC 1883 was adopted in 1995. The IPv6-standard is also known as “IP Next Generation” or “IPng”. In 1998, a document RFC 2460 redefined the IPv6 standard rendering the document RFC 1883 obsolete.

The IPv4-standard employs IPv4 datagrams which utilize a fixed header of 20 bytes, an options data region in a range up to 40 bytes long and a data payload region having a length of 64 kBytes minus the length of said IPv4 header. In contradistinction, the IPv6-standard provides an expanded and revised addressing scheme that accommodates growth and increases routing efficiency on account of header format simplification, improved support for options, automatic address configurations, mobility support, authentication and privacy facilities similar to contemporary IPSec, and a new “anycast” address type. Moreover, the IPv4-standard employs addresses which are 32 bits long which yields 4.2×10⁹ different addresses whereas the IPv6-standard employs addresses which are 128 bits long which yields 3.4×10³⁸ different addresses.

The inventors have appreciated that many communication networks presently in use are heterogeneous, for example employing a mixture of routers conforming to IPv4- or IPv6-standards. Such heterogeneous configurations arise as a consequence of existing networks being subject to ongoing upgrades to newer standards whilst maintaining infrastructure conforming to earlier standards. Thus, the inventors have devised a method of enabling automatic take-over and dynamic assignment of IPv6-standard router functionality to an IPv6-standard device in heterogeneous IPv6/IPv4-standard networks. The method contrasts with related contemporary methods which rely on IPv4-standard and IPv6-standard router functionality which are statically assigned to a router device. Moreover, it is envisaged that the method devised by the inventors is also applicable to other standards employed in data communication networks and not solely limited to the aforementioned IPv4- and IPv6-standards.

A first object of the invention is to provide a communication network including one or more routers therein, the network functioning according to a method which imparts greater reliability thereto.

A second object of the invention is to provide a watching function suitable for monitoring and directing operation of a communication network including routers to enhance reliability of the network when one or more routers fail or otherwise become unavailable.

According to a first aspect of the present invention, there is provided a method of automatically transferring router functionality, characterized in that the method includes steps of:

(a) providing a data communication network including one or more candidate devices dynamically assignable as routers within the network for routing data traffic therethrough;

(b) providing watching means for monitoring activity of the one or more candidate devices and delegating authority to one or more of the devices to provide a data-routing function thereat;

(c) arranging for each candidate device to include a first record stored locally therein of one or more routers that it assumes to be active in the network;

(d) arranging for each candidate device to monitor the network to determine one or more routers presently active on the network and generate a corresponding second record of active routers;

(e) arranging for each candidate device to compare its first and second records;

(f) when one or more of the candidate devices in step (e) determine the first and second records to be non-equivalent, arranging for the one or more devices to be updated with more recent first records from the watching means;

(g) when one or more of the candidate devices in step (e) determine that their own address matches that of the first records, arranging for these one or more candidate devices to assume function as routers within the network; and

(h) repeating steps (a) to (g) as required.

The invention is of advantage in that the one or more candidate devices are susceptible to being reconfigured by the method so as to enhance data routing reliability within the network.

Preferably, in the method, the one or more candidate devices are arranged to function as IPv6-standard routers. In this respect, the inventors have appreciated that the IPv6 standard exhibits a potential weakness with regard to routing robustness which the present invention is well suited to address.

Preferably, in the method, the watching means and one or more candidate devices are operable to monitor router activity within the network in steps (b) and (d) by way of link local data advertised within the network. Analysis of advertised link data enables the watching means and the one or more candidate devices to determine routing pathways within the network.

Preferably, in the method, the watching means is operable to selectively activate and deactivate one or more candidate devices in the network for resolving conflict between multiple competing routers active within the network. Enabling the watching means to take executive decisions regarding choice of router employed is of advantage in that it is susceptible to reducing conflicts between several concurrently operating routers.

Preferably, in the method, the watching means is operable to assign one of the candidate devices in a situation where no routers are at least locally active in the network. Such an approach is capable of imparting the network with reliable booting-up characteristics when initially energized.

Preferable, the method is adapted to cope with the network when implemented as a heterogeneous IPv4-/IPv6-standard network. The ability of the network to cope with such heterogeneity renders the network more pertinent to contemporary mixed-standard networks.

According to a second aspect of the present invention, there is provided a method of operating the watching means as claimed in the first aspect of the invention, characterized in that the method includes steps of:

(i) receiving at least one communication from one or more candidate devices at the watching means, the at least one communication including details of the first records of the candidate devices;

(j) checking that the first records in step (i) correspond to a record of candidate router maintained at the watching means for determining activation and/or deactivation of candidate routers;

(k) monitoring router activity at least locally within the network;

(l) updating the one or more candidate devices regarding which of the candidate devices are to be active and which are to be inactive; and

(m) updating the record of candidate router maintained at the watching means.

According to a third aspect of the present invention, there is provided a communication network including one or more candidate devices operable to function as routers according to the method of the first aspect of the invention.

According to a fourth aspect of the present invention, there is provided a candidate device operable as a router according to the method of the first aspect of the invention.

According to a fifth aspect of the present invention, there is provided a router monitoring device including watching means operable according to the method of the second aspect of the invention.

It will be appreciated that features of the invention are susceptible to being combined in any combination without departing from the scope of the invention.

Embodiments of the invention will now be described, by way of example only, with reference to the following diagrams wherein:

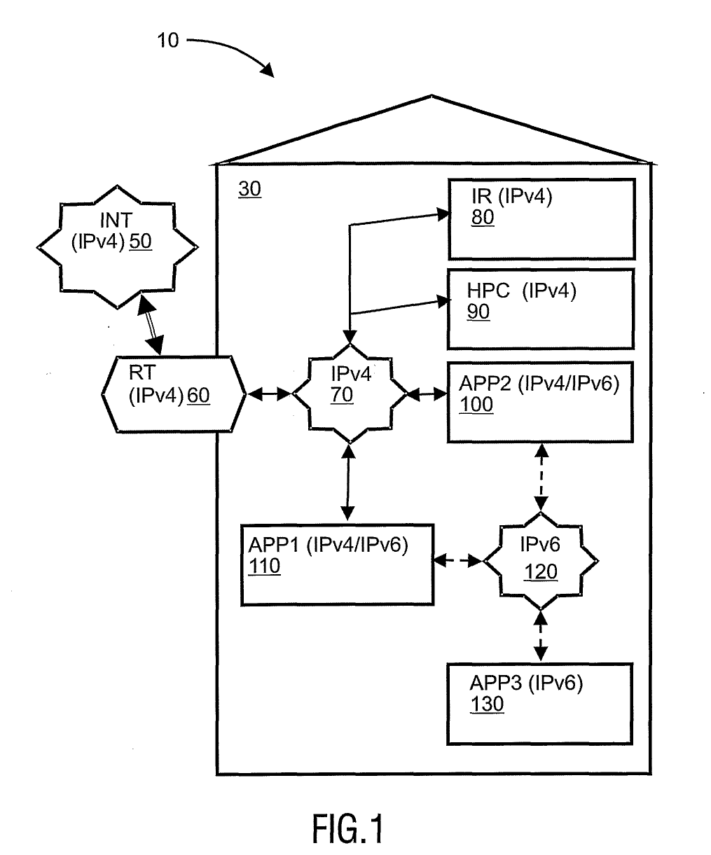

FIG. 1 is an illustration of a first network comprising a heterogeneous mixture of IPv4-standard and IPv6-standard appliances;

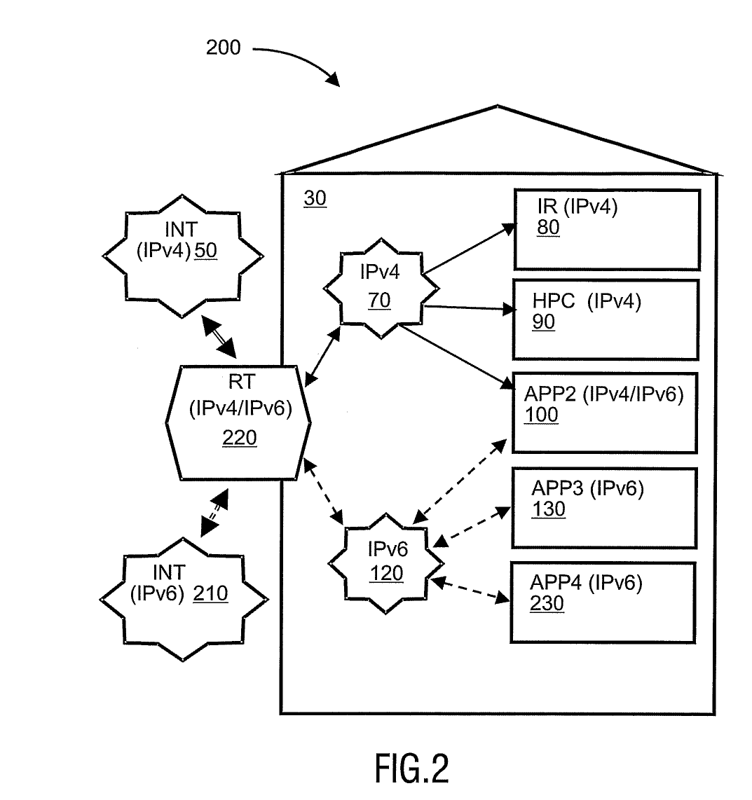

FIG. 2 is an illustration of a second network comprising a heterogeneous mixture of IPv4-standard and IPv6-standard appliances;

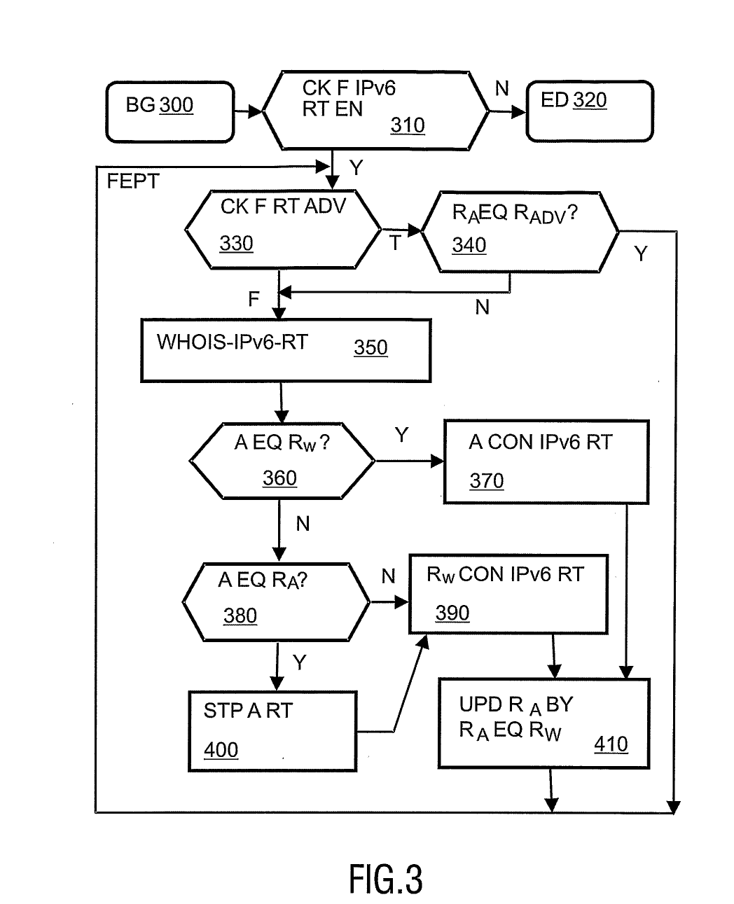

FIG. 3 is a flow chart of a method of rendering appliances or devices included within the networks of FIGS. 1 and 2 active to take over as Candidates for IPv6 routing functionality; and

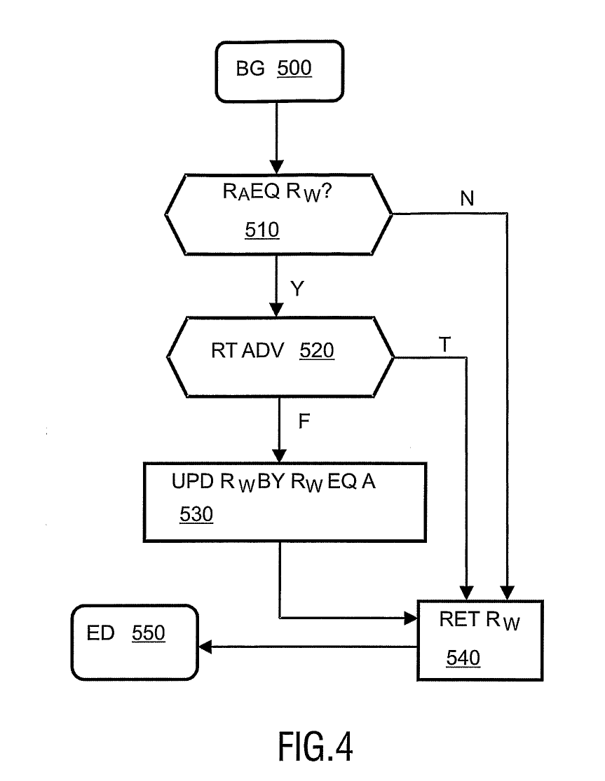

FIG. 4 is a flow chart of a complementary method required in conjunction with the method depicted in FIG. 3 for supervising, namely watching, the appliances or devices subject to the method depicted in FIG. 3.

The present invention in concerned with a method of enabling automatic take-over and dynamic assignment of IPv6-standard router functionality to an IPv6-standard appliance in a heterogeneous IPv6-/IPv4-standard network. Such a method is in contradistinction to contemporary solutions which rely on IPv4-standard and IPv6-standard functionality which is statically assigned to a router device.

Contemporary IPv6 appliances having IPv6-standard router functionality built thereinto by their vendors are operable to detect availability of other IPv6-standard routers connected thereto. Such other IPv6-standard routers are potentially unavailable for a variety of potential reasons, for example:

(a) plug-out, namely disconnection;

(b) insufficient power or interruption of power;

(c) unexpected failure, for example internal electronic device failure; or

(d) temporary unresponsiveness, for example arising from software endless looping.

A contemporary problem is that unavailability of an IPv6 router connected as part of an IPv6-standard device cluster can potentially result in complete unresponsiveness of the whole IPv6-standard cluster. A domestic home IP network is an example of a device cluster, for example comprising home Internet radio, home personal computer (PC), home Internet television and home burglary security system susceptible to sending and/or receiving data via the Internet from locations remote therefrom. Such a characteristic is susceptible to rendering configurations of IPv6-standard devices potentially more unreliable in use than technically necessary.

In order to address this contemporary problem, the inventors have devised a method of monitoring IPv6-standard routers in a home network, the method providing for automatic replacement in case of unavailability as well as detection of illegal IPv6-standard routers. Unavailable and illegal routers are susceptible to arising in practice if an IPv6-standard router becomes temporarily unresponsive for reasons (a) to (d) provided in the foregoing. An IPv6-standard router functioning according to the method is operable to take over the functionality of an IPv6 router which becomes unavailable until the router returns to functionality again. Thus, for a instance of time, the method allows for multiple routers to be detected and appropriate steps to be taken for stopping one or more of the routers to prevent clusters of IPv6 standard devices as a whole becoming disabled.

In order to better elucidate the context of the invention, a data communication network indicated generally by 10 in FIG. 1 will now be described. The network 10 includes a domestic premises 30 coupled by a conventional IPv4-standard router (RT) 60 to the Internet (INT) 50 in a part thereof functioning according to the contemporary IPv4 standard. The router 60 is operable to create an IPv4-standard local communication environment (IPv4) 70 within the premises 30 as illustrated; the IPv4-standard environment 70 is preferably implemented as a local area wireless and/or wired network or fiber optic signal distribution arrangement such as one or more multiplexed connection panels.

Coupled to the IPv4-standard environment 70 are diverse devices such as an Internet radio (IR) 80 and a home personal computer (HPC) 90; the radio 80 and the computer 90 are also operable to receive data content from and send data content to the environment 70 pursuant to the aforementioned IPv4-standard. Moreover, a first appliance (APP1) 110 and a second appliance (APP2) 100 are also coupled to the environment 70. The appliances 100, 110 are both capable to providing a conversion from the IPv4 standard pertaining to the environment to the IPv6 standard pertaining to an IPv6-standard environment 120. The two environments 70, 120 are susceptible to being spatially overlapping when implemented as, for example, a local area wireless network. In the premises 30, there is also included a third appliance (APP3) 130 operable when communicating to conform to the IPv6 standard. As far as the third appliance 130 is aware, the third appliance 130 is transparently hosted to the IPv6 standard.

Operation of the network 10 will be further elucidated later.

It will be appreciated that the network 10 is heterogeneous with sub-parts thereof functioning to the IPv4 standard and to the IPv6 standard. Moreover, alternative network configurations are also feasible, for example as illustrated in FIG. 2.

In FIG. 2, there is shown a data communication network indicated generally by 200. The network 200 includes the domestic premises 30 coupled via a versatile router (RT) 220 which is capable of coping with data content from a part of the Internet functioning according to the IPv4 standard, namely the Internet (INT) 50, and from a part of the Internet functioning according to the IPv6 standard, namely the Internet (INT) 210. The versatile router 220 is operable to create IPv4-standard and IPv6 standard environments 70, 120 within the premises respectively. To the IPv4-standard environment 70 is coupled the Internet radio (IR) 80 and the home personal computer (HPC) 90 as well as the second appliance (APP2) 100. The second appliance 100 is also couplable to the IPv6-standard environment 120 as illustrated. The third appliance (APP3) 130 and a fourth appliance (APP4) 230 also complying to the IPv6 standard are coupled to the IPv6-standard environment 120 as represented by dotted arrows.

The router 60 in FIG. 1 conforms only to the IPv4-standard, whereas the router 220 in FIG. 2 conforms to both IPv4- and IPv6-standards, although the networks 10, 200 are both heterogeneous home networks. These networks 10, 200 are operable to provide hosts which are either IPv4-standard or IPv6-standard only, or dual-stack IPv6/IPv4-standard. For example, in the network 10, the first appliance 110 performs a role of an IPv6-standard router for a IPv6-standard cluster of appliances including the second appliance 100 and the third appliance 130. Moreover, in the network 200, the router 220 is an integrated router conforming to both IPv4- and IPv6-standards. An operating characteristic of the networks 10, 200 is that their dynamics are capable of giving rise to appearance of new network nodes therein and disappearance of existing network nodes.

In the networks 10, 200, the inventors have appreciated that a problem exists regarding determining IPv6-standard router unavailability. Such unavailability, as elucidated also in the foregoing, can arise on account of one or more of the following reasons:

(a) “plug-out”, namely disconnection;

(b) power failure;

(c) unexpected hardware failure; and

(d) temporary unresponsiveness, for example software “lock-up”.

The unavailability of IPv6-standard routing functionality in the networks 10, 200 results in disconnection of associated IPv6-standard appliance or device clusters as described in the foregoing. The inventors have identified that a solution to a problem of clusters of devices becoming disconnected on account of failure of their associated router is essential for ensuring the robustness of the networks 10, 200 and hence achieving user satisfaction. In solutions envisaged by the inventors, it is a pre-requisite that IPv4-standard router functionality in a local network, for example as depicted in FIGS. 1 and 2 in respect of the premises 30, remains reliably operational.

In order to elucidate the present invention, it is convenient to employ a system of terminology wherein an IPv6-standard appliance susceptible to functioning as a router is designated an “IPv6 Router Candidate” or simply “Candidate”; for example the first and second appliances 110, 100 in the network 10 of FIG. 1, and the second appliance 100 in the network 200 of FIG. 2 are to be regarded as “Candidates”. Thus, the inventors have appreciated that a solution to the aforementioned problem of whole IPv6-standard clusters becoming disconnected is to automatically detect router unavailability and use one or more “Candidates” to take over IPv6-standard router functionality to maintain communication to the clusters. Such use of “Candidates” requires a method according to the invention to be adopted in order to ensure reliable operation of the network 10, 200. Although the inventors have appreciated that IPv6-standard router functionality is conventionally statically assigned, IPv6-standard router functionality is susceptible to being dynamically assigned by utilizing the method of the invention.

In the method, an IPv6-standard router is detectable by monitoring router advertisements communicated on its associated link local interface. If an IPv6-standard router is available, each IPv6-standard device, including the router itself, connected to the router will receive router advertisements containing an IPv6-standard prefix which each of the devices is permitted to use for stateless auto-configuration as described in a document RFC 2462 December 1998 which is herewith incorporated by reference; here, “RFC” is an abbreviation for “Request for Comments”. Each of the devices receiving these router advertisements is capable of retrieving an IPv6-standard link local address of the router, for example as described in a document RFC 2373 July 1998 which is herewith incorporated by reference. Thus, the inventors have appreciated that an absence of aforesaid router advertisements is indicative of IPv6-standard router unavailability.

In the method of the invention, it is therefore desirable to include functionality to monitor IPv6-standard router activity in a heterogeneous IPv4/IPv6 communication network. Thus, the networks 10, 200 include an IPv6-standard router watcher as a keeper of the IPv6 link local address of the currently active IPv6-standard router. Such functionality will hereinafter be referred to as Watcher. A suitable candidate for a Watcher is an IPv4-standard node, for example an IPv4-standard router which remains operational independently of the status of a connected IPv6-standard cluster of devices. However, the inventors have appreciated that an IPv4-standard Watcher that is only operable with IPv4 data content does not conventionally receive IPv6-standard router advertisements. Conventionally, an IPv4-standard Watcher will execute a decision regarding a device to take over from a failed IPv6-standard router based on an interaction, known as an “API” which is an abbreviation for “Application Programming Interface”, that aforementioned “Candidates” execute with the Watcher. An abbreviation used hereinafter for such an API-type interaction is “WhoIsIPv6Router”.

The inventors have appreciated that, superficially, a simple method of taking over functionality of an IPv6-standard router could be based on a simple rule: “an IPv6-standard router Candidate that does not receive router advertisements from an established IPv6 router can be operable to take over functions of that established IPv6 router”. However, this simple method potentially suffers a problem of multiple IPv6-standard router Candidates trying to simultaneously take over the function of the established IPv6 router that has failed; a clash situation can potentially arise. In order to circumvent such a clash, the inventors have devised an improved method wherein a Watcher is arranged to take decisions regarding which IPv6-standard Candidate router is allowed to start functioning as an IPv6 router to replace the failed established IPv6 router. In the improved method, the IPv6 Candidate that takes over functionality as a IPv6 router is the one which first executes the aforesaid “WhoIsIPv6Router” API with the Watcher subject to a condition that this API can only be executed within an associated fixed timeslot between the Watcher and each IPv6-standard Candidate.

The method of the invention will now be described in more detail with respect to FIGS. 1 to 4. In order to elucidate the method of the invention, the notations as provided in Table 1 will hereinafter be employed.

TABLE 1

| Notation: | Interpretation: |
|---|---|
| A | An IPv6 link local address of a Candidate that executes the method. For simplicity, |
| | terminology “Candidate A” or simply “A” is employed hereinafter to mean “Candidate with |
| | address A” |
| R_{A} | An IPv6 link local address of an IPv6 router monitored by Candidate A; where Candidate A |
| | is operable to record this link local address locally in its memory |
| R_{ADV} | An IPv6 link local address of an IPv6 router that Candidate retrieves from router |
| | advertisements; wherein Candidate A is operable to record this link local address locally in |
| | its memory |
| R_{W} | An IPv6 link local address of an IPv6 router monitored by a Watcher, wherein a Watcher is |
| | operable to record this link local address locally in its memory |
| RouterAdv | a Boolean variable that is “true” (T) if there are router advertisements, otherwise the variable |
| | has a state “false” (F) |
| T | a period of time |

Operation of the method of the invention within the networks 10, 200 is subject to certain rules being observed. These rules are elucidated in Table 2 wherein each Candidate, for example a Candidate having an associated IPv6 link local address A (namely Candidate A), is operable to check the router advertisements according to the rules.

TABLE 2

| Rule: | Details: |
|---|---|
| 1 | If no router advertisements are detected, Candidate A is not able to retrieve the IPv6 link local |
| | address (R_{ADV}) of the IPv6 router from the advertisements, namely RouterAdv = “false”; Candidate |
| | A is then operable to request the Watcher WhoIsIPv6Router (A, R_{A}, RouterAdv), after which Rule |
| | 3 is implemented. |
| 2 | If router advertisements are detected, Candidate A is able to retrieve the IPv6-standard link local |
| | address (R_{ADV}) of the IPv6 router from the advertisements, namely RouterAdv = “true”; Candidate |
| | A is then operable to compare the locally available variable R_{A} with the variable R_{ADV} retrieved |
| | from the router advertisements as follows: |
| | 2.1: when R_{A} and R_{ADV} are identical, this is indicative that the Candidate A has updated |
| | information over the IPv6 router and after a period of time T will continue to monitor the |
| | availability of the IPv6 router in the network 10,200. |
| | 2.2: when R_{A} and R_{ADV} are not identical, this is indicative that the Candidate A has outdated |
| | information over the IPv6 router; in such a situation, simply updating to equate R_{A} = R_{ADV} |
| | potentially results in deadlock if there are two IPv6 routers of which one is illegal. In order to |
| | avoid such a deadlock, Candidate A executes the WhoIsIPv6Router(A, R_{A}, RouterAdv) API with |
| | the Watcher and then proceeds to execute Rule 3. |
| 3 | Candidate A asks the Watcher for WhoIsIPv6Router(A, R_{A}, RouterAdv) which results in the |
| | Watcher comparing the locally available variable R_{W} and the variable R_{A} passed as a parameter |
| | and then performs the following checks: |
| | 3.1: when R_{W} is not equal to R_{A}, the IPv6 node having an IPv6 link local address R_{W} not equal to |
| | R_{A} is then identified as an IPv6 router; the Watcher returns the variable R_{W} to Candidate A after |
| | which Rule 4 is executed. |
| | 3.2: when R_{W} is equal to R_{A} as well as RouterAdv is “false”, this is interpreted to indicate that no |
| | IPv6 router is presently available on the network 10,200 yet. In such a situation, the Watcher |
| | executes a decision that Candidate A can start as an IPv6 router, after which R_{W} is updated to the |
| | address A and the variable R_{W} is returned to Candidate A, after which Rule 4 is executed. |
| | 3.3: when R_{W} is equal to R_{A} as well as RouterAdv is “true” as consequence of R_{ADV} not being |
| | equal to R_{A}, this is indicative of their being at least two routers on the network. In such a situation, |
| | the Watcher decides that R_{W} is the IPv6 router and returns R_{W} to Candidate A which then proceeds |
| | to execute Rule 4. |
| 4 | Candidate A receives R_{W} from the Watcher and compares the variable R_{W} with its own address A |
| | to perform the following checks: |
| | 4.1: if R_{W} is equal to A, then Candidate A takes over the functionality of the IPv6 router, after |
| | which Rule 5 is executed. |
| | 4.2: if R_{W} is not equal to A, then Candidate A compares the variables R_{A} with its own address A |
| | wherein: |
| | 4.2.1: R_{A} equal to A enables the Candidate A to detect that it was functioning as an IPv6 router but |
| | another Candidate with address R_{W} has taken over while Candidate A was temporarily unavailable; |
| | consequently, Candidate A stops as an IPv6 router and then proceeds to execute Rule 5. |
| | 4.2.2: R_{A} not equal to A enables the Candidate A to detect that a node with address R_{W} is the IPv6 |
| | router and then proceeds to execute Rule 5. |
| 5 | Candidate A upgrades R_{A} with the address of the new IPv6 router returned from by the Watcher |
| | (R_{W}), namely R_{A} = R_{W}. Candidate A then proceeds to monitor the availability of IPv6 routers on |
| | the networks 10,200 after a period of time T. |

The Rules 1 to 5 provided in Table 2 are also represented diagrammatically in FIG. 3 where decision points arising when implementing the method are more discernible. In FIG. 3, abbreviations are used which have corresponding interpretations as defined in Table 3.

TABLE 3

| Feature | | |
|---|---|---|
| number | Abbreviation | Interpretation |
| 300 | BG | Begin step |
| 310 | CK F IPv6 RT EN | Check if IPv6 router enabled ? |
| 320 | ED | End step |
| 330 | CK F RT ADV | Check if there are router advertisements, |
| | | namely RouterAdv |
| 340 | R_{A} EQ R_{ADV} ? | Is R_{A} equal to R_{ADV} ? |
| 350 | WHOIS-IPv6-RT | Execute the protocol WholsIPv6Router(A, |
| | | R_{A}, RouterAdv) with the IPv6 Router |
| | | Watcher in order to obtain updated |
| | | address of the IPv6 Router R_{W}. |
| 360 | A EQ R_{W} ? | Is A equal to R_{W} ? |
| 370 | A CON IPv6 RT | The node with address A is confirmed |
| | | to be the IPv6 router |
| 380 | A EQ R_{A} ? | Is A equal to R_{A} ? |
| 390 | R_{W} CON IPv6 RT | The node with address R_{W} is |
| | | confirmed as being the IPv6 router |
| 400 | STP A RT | Stop A as a router |
| 410 | UPD R_{A} BY | Update R_{A}, |
| | R_{A} EQ R_{W} | namely R_{A} = R_{W} |
| | FEPT | For each period T |
| | Y, N | Yes, No |
| | T, F | True, False |

The method as provided in Rule-form in Table 2 will now be described with reference to FIG. 3.

In FIG. 3, there is shown a flow chart corresponding to the method of the invention. The flow-chart is to be interpreted with reference to the heterogeneous network 10 of FIG. 1, although it is equally applicable to the network 200 of FIG. 2. Each Candidate is operable to execute the method of the invention, for example in computing hardware included within each Candidate, when booted-up. Such boot-up results in each Candidate either upgrading information therein regarding a currently active IPv6-standard router, or automatically configuring itself as an IPv6-standard router if there is a absence of any IPv6-standard router available in the network 10.

At step 300 of the flow chart, a given Candidate is energized, namely booted-up. In subsequent step 310, the Candidate A checks to determine whether or not it is enabled to function as an IPv6-standard router; a manufacturer of the Candidate A will determine whether or not it is potentially capable of functioning as a router, for example by including appropriate hardware therein and/or setting software parameters accordingly. If the Candidate A is an appliance which is resource constrained, for example on account of possessing limited processor (CPU) and associated memory capacity, or dedicated to performing specific functions such as audio-video streaming, the manufacturer may consider that the Candidate is unsuitable for providing IPv6 router functionality. Thus, the Candidate A which is not enabled to function as router but nevertheless implementing the method would proceed to step 320 corresponding to an end stop state resulting in cessation of executing the method therein; conversely, where the Candidate A is enabled by its manufacturer to function as a router, the method progresses from step 310 to step 330.

At step 330, the Candidate A checks if there are any routers advertising themselves on the network 10 indicating that there is already an active IPv6-standard router in operation in the network 10. If the Candidate A finds that RouterAdv=“true” confirming there to be an active router, the method progresses to step 340; conversely, if the Candidate A finds that RouterAdv=“false” confirming there to be an absence of an active router, the method progresses to step 350.

At step 340, the Candidate A checks if the locally available variable R_{A} (address which the Candidate A monitors) is equal to the variable R_{ADV} (address retrieved by the Candidate A which is advertised). If none of the Candidates A present have outdated information regarding the IPv6 router to be employed (namely variables R_{A} and R_{ADV} unequal), the method progresses to step 350; conversely, the Candidates A present have updated information on the IPv6 router, the Candidates A after a period of time T proceeding back to step 330 to monitor availability of the IPv6 router.

At step 350, the Candidate A executes a WhoIsIPv6Router(A, R_{A}, RouterAdv) with the Watcher in order to receive information which device or appliance can take over, or has already taken over, functionality of the IPv6 router. Information regarding such an appliance or device is returned as the variable R_{W}. On completion of step 350, the method progresses to step 360.

At step 360, the Candidate A checks to determine whether or not the variable R_{W} returned by the Watcher in step 350 is equal to its own IPv6 link local address A. If equivalence is determined, namely option “Y”, then Candidate A is the IPv6 router and the method subsequently proceeds from step 360 to step 370; otherwise, the method proceeds from step 360 to step 380, namely option “N”.

At step 370, the Candidate A is confirmed to be, or becomes, the IPv6 router (by checking its own local IPv6 address) and the method then proceeds to step 410.

At step 380, the Candidate A checks if the locally available variable RA equals its own IPv6 link local address A. If equivalence is determined, namely option “Y”, the Candidate A detects that it was an IPv6 router but another appliance or device having an address corresponding to the variable Rw has taken over whilst Candidate A was temporarily unavailable; the method then progresses to step 400. Conversely, if non-equivalence is determined, namely option “N”, the method progresses directly to step 390.

At step 400, the Candidate A stops functioning as an IPv6 router as progression of the method to step 400 is indicative of the Candidate A having functioned as an illegal IPv6 router. The method then subsequently progresses to step 390.

At step 390, the Candidate A concludes that a node with an address equal to the parameter R_{W} is the IPv6 router. The method thereafter proceeds to step 410.

At step 410, the Candidate A upgrades the variable R_{W} with the address of the new IPv6-standard router on the network 10 returned by the Watcher, namely R_{A}=R_{W}; after a period T, the Candidate A continues to monitor the availability of the IPv6 router on the network 10 by progressing back to step 330 is illustrated in FIG. 3.

In the method depicted in FIG. 3, there is employed the WhoIsIPv6Router API, namely “Application Programming Interface”, provided by the Watcher. The Candidate A is operable to call this API via a “Remote Procedural Call”, namely RPC.

It will be appreciated from the foregoing description of the method of the invention with reference to FIG. 3 that it is executable on a device or appliance, namely a Candidate, which is potentially capable of taking responsibility for IPv6-standard data content routing. The method depicted in FIG. 3 accesses the Watcher. This Watcher is also operable according to a complementary method as depicted in FIG. 4 for implementing the aforementioned WhoIsIPv6Router function. Abbreviations employed in FIG. 4 have associated interpretations as provided in Table 4.

TABLE 4

| Feature | | |
|---|---|---|
| number: | Abbreviation: | Interpretation: |
| 500 | BG | Begin step |
| 510 | R_{A} EQ R_{W} ? | Check if R_{A} is equal to R_{W} ? |
| 520 | RT ADV | Check the value of the variable |
| | | RouterAdv |
| 530 | UPD R_{W} BY R_{W} EQ A | Update R_{W}, namely R_{W} = A |
| 540 | RET R_{W} | Return address of IPv6 router to |
| | | Candidate A |
| 550 | ED | End step |
| | Y, N | Yes, No |
| | T, F | True, False |

In FIG. 4, the complementary method commences with step 500, called at step 350 in FIG. 3. The complementary method then progresses to step 510 whereat the Watcher checks whether or not the variable R_{A} passed as a parameter is equal to the locally available value of variable R_{W}. If there is no equivalence, namely the “N” option, then Candidate A has outdated information on the IPv6 router being employed, thus the new router corresponds to variable R_{W}; the complementary method then progresses to step 540. Conversely, where equivalence is found, namely the “Y” option, the complementary method progresses from step 510 to step 520.

At step 520, the complementary method checks if the variable RouterAdv passed as a parameter is “true”. If equivalence is identified, namely a “true” identification arises, the complementary method progresses to step 540. Conversely, if non-equivalence is identified, namely a “false” identification arises, the complementary method progresses to step 530.

At step 530, the complementary method is operable to detect whether or not an IPv6 node having an address R_{W} was an IPv6 router in the network 10 but which is no longer available on account of their being no corresponding advertisements; if affirmative, the complementary method decides that an IPv6 node having an address A is permitted to take over as an IPv6 router. The complementary method then progresses from step 530 to step 540.

At step 540, the complementary method returns the address of the IPv6 router to the Candidate A. Thereafter, the complementary method progresses to an end step 550.

Both the method illustrated in FIG. 3 as implemented in devices or appliances capable of functioning as IPv6 routers and its associated complementary method illustrated in FIG. 4 are susceptible to being implemented as algorithms, for example as executable software. Alternatively, or additionally, these methods are also susceptible to being implemented as custom hardware, for example as one or more application-specific integrated circuits.

In order to elucidate further operation of the methods of FIGS. 3 and 4, some example scenarios arising within the network 10 will now be described.

Scenario 1 Initially on boot-up

Setup: On initial start-up of the networks 10, 200, initial values for the variable R_{A} at each Candidate is zero, namely R_{A}=0. Similarly, the initial value for the variable R_{W} at the Watcher is zero, namely R_{W}=0. Only Candidates which are IPv6-standard router-enabled appliances start executing the method as depicted in FIG. 3.

Scenario 1.1: A Candidate A₁, namely the first appliance (APP1) 110, is the first that boots up. Subsequently, Candidate A₁ executes in sequence steps 330, 350, 360, 370 and finally 410. At step 350, the Watcher executes in sequence steps 510, 520, 530 and finally 540. As an outcome of executing these two sequences of steps, the Candidate A₁, namely the appliance 110, starts to function as an IPv6-standard router thereby coupling the appliance (APP3) 130 to the router 60 providing the IPv4-standard environment 70.

Scenario 1.2: The Candidate Aₖ (k>1) executes a sequence of steps 330, optionally 340, 350, 360, 380, 390 and finally 410. When the Candidate Aₖ executes step 350, the Watcher executes step 510 and finally 540.

As a consequence of these sequences of steps, the Candidate A₁, namely the appliance 110, starts to function as an IPv6-standard router thereby coupling the appliance (APP3) 130 to the router providing the IPv6-standard environment 120.

Scenario 2: an existing IPv6 router becomes unavailable, for example Candidate A₁ becomes unresponsive

Setup: Candidate A₁ was functioning as the active IPv6 router in the network 10 and then suddenly became unresponsive in the network 10; similar considerations pertain to the network 120. The value of the variable RA at each Candidate, namely at each of the appliances 100, 110, 130 is: R_{A}=A₁. The value of the variable Rw at the Watcher is: R_{W}=A₁. In such a situation where the Candidate A₁ fails, all IPv6-standard devices present in the premises 30 will no longer receive router advertisements. When the Candidates, namely the appliances 100, 110, detect such lack of advertisements, the Candidates then implement aforementioned “WhoIsIPv6Router” step 350 as depicted in FIG. 3.

Scenario 2.1: the Candidate A₂, namely the appliance 100, is the first Candidate that detects the IPv6 router, namely the appliance 110, to be unavailable. Subsequently, the Candidate A₂ executes a sequence of steps 330, 350, 360, 370 and finally 410. Whilst executing step 350, the Watcher executes a sequence of steps 510, 520, 530 and finally 540.

As a consequence of these sequences of steps, the Candidate A₂, namely the appliance 100, takes over from the Candidate A₁, namely the appliance 110, the function of being the IPv6 router in the IPv6-standard environment 120.

Scenario 2.2: each next Candidate Aₖ, where an index k>2, (not shown in FIG. 1), is a set of Candidates not including the Candidates A₁ and A₂. Subsequently, the Candidates Aₖ where the index k>2 each executes a sequence of steps 330, optionally 340, 350, 360, 380, 390, 410; when step 350 is being executed in the Candidates Aₖ, the Watcher executes the steps 510 and 540 of the complementary method depicted in FIG. 4.

As a consequence of these sequences of steps, the Candidate A₂, namely the appliance 100, takes over from the Candidate A₁, namely the appliance 110, the function of being the IPv6 router in the IPv6-standard environment 120.

Scenario 3: more than one appliance or device sends router advertisements; presence of an “illegal” router in the network 10; similar considerations pertain to the network 200.

Setup:

(a) the Candidate A₁, namely the appliance 110, was functioning as an active IPv6 router but became subsequently unavailable;

(b) the Candidate A₂, namely the appliance 100, takes of function as being the IPv6 router with a result the value of the variable R_{A} at each Candidate, except the Candidate A₁, becomes: R_{A}=A₂, and the value of the variable R_{W} at the Watcher becomes: R_{W}=A₂; and

(c) the Candidate A₁ returns after its period of unavailability and becomes active again without being re-initialized; consequently, the value of the variable R_{A} at the Candidate A₁ is still: R_{A}=A₁.

The network 10 will, for a certain time, have two routers functioning, namely both Candidates A₁, A₂. Consequently, each Candidate including the Candidates A₁, A₂, will receive router advertisements from the Candidates A₁, A₂ wherein one of these two Candidates A₁, A₂ is illegal. In such a situation, several scenarios are susceptible to arising which the methods of FIGS. 3 and 4 are arranged to cope with.

Scenario 3.1: the Candidate A₁ receives its own IPv6 router advertisements. It proceeds to execute steps 330, 340 after which it monitors the network 10 again after the period of time T. In consequence, the network 10 is not reconfigured within the premises 30.

Scenario 3.2: the Candidate A₁ receives IPv6 router advertisements from the Candidate A₂. Subsequently, the Candidate A₁ executes a sequence of steps 330, 340, 350, 360, 380 and finally 410. During step 350, the Watcher executes a sequence of steps 510 and 540. In consequence, the Candidate A₁ stops functioning as an IPv6 router and it is updated with information that the Candidate A₂ is now the authorized router.

Scenario 3.3: the Candidate A₂ receives its own IPv6 router advertisements. It proceeds to execute steps 330, 340 after which it monitors the network 10 again after the period of time T. In consequence, the network 10 is not reconfigured within the premises 30.

Scenario 3.4: the Candidate A₂ receives IPv6 router advertisements from the Candidate A₁. Subsequently, the Candidate A₂ executes a sequence of steps 330, 340, 350, 360, 370 and finally 410. During step 350, the Watcher executes a sequence of steps 510, 520 and finally 540. In consequence, the Candidate A₂ remains the IPv6 router in the premises 30.

Scenario 3.5: each next Candidate Aₖ, wherein the index k>2, receives IPv6 router advertisements from the Candidate A₁. Subsequently, the Candidate Aₖ executes a sequence of steps 330, 340, 350, 360, 380, 390 and finally 410. At step 350, the Watcher executes a sequence of steps 510, 520 and finally 540. In consequence, the Candidate A₂ remains the IPv6 router in the premises 30.

Scenario 3.6: each next Candidate Aₖ, wherein the index k>2, receives IPv6 router advertisements from the Candidate A₂. Subsequently, the Candidate Aₖ executes a sequence of steps 330 and finally 340 and will then monitor the network 10 again after the period of time T. In consequence, the Candidate A₂ remains the IPv6 router in the premises 30.

The methods of FIGS. 3 and 4 thus provide a robust approach to providing IPv6-standard routing functionality with the network 10. Similarly, the methods are also susceptible to being used in the network 200 and other relates types of networks. Moreover, the methods of FIGS. 3 and 4 is capable of providing IPv6 router-enabled nodes which are operable to be capable of automatically taking over IPv6-standard router functionality.

Additionally, the methods of FIGS. 3 and 4 allow for dynamically changing configurations where potential routers become available and/or non-available with time in a complex heterogeneous-standard network; such dynamic versatility is to be contrasted with contemporary networks including IPv6 routers which employ static topologies.

The methods of FIGS. 3 and 4 are therefore susceptible to enhancing robustness of the networks 10, 200. However, although the present invention is described in the context of the IPv4- and IPv6-standards, it will be appreciated that the invention is also applicable to other standards.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

1. A method of automatically transferring router functionality, characterized in that the method includes steps of:
(a) providing a data communication network including one or more candidate devices dynamically assignable as routers within the network for routing data traffic therethrough;
(b) providing watching means for monitoring activity of the one or more candidate devices and delegating authority (R_{W}) to one or more of the devices to provide a data-routing function thereat;
(c) arranging for each candidate device to include a first record (R_{A}) stored locally therein of one or more routers that it assumes to be active in the network;
(d) arranging for each candidate device to monitor the network to determine one or more routers (R_{ADV}) presently active on the network and generate a corresponding second record of active routers;
(e) arranging for each candidate device to compare its first and second records;
(f) when one or more of the candidate devices in step (e) determine the first and second records to be non-equivalent, arranging for the one or more devices to be updated with more recent first records from the watching means;
(g) when one or more of the candidate devices in step (e) determine that their own address matches that of the first records, arranging for these one or more candidate devices to assume function as routers within the network; and
(h) repeating steps (a) to (g) as required.

2. A method according to claim 1, wherein the one or more candidate devices are arranged to function as IPv6-standard routers.

3. A method according to claim 1, wherein the watching means and one or more candidate devices are operable to monitor router activity within the network in steps (b) and (d) by way of link local data advertised within the network.

4. A method according to claim 1, wherein the watching means is operable to selectively activate and deactivate one or more candidate devices in the network for resolving conflict between multiple competing routers active within the network.

5. A method according to claim 1, wherein the watching means is operable to assign one of the candidate devices in a situation where no routers are at least locally active in the network.

6. A method according to claim 1, wherein the network is a heterogeneous IPv4-/IPv6-standard network.

7. A method of operating the watching means as claimed in claim 1, characterized in that the method includes steps of:
(i) receiving at least one communication from one or more candidate devices at the watching means, the at least one communication including details of the first records of the candidate devices;
(j) checking that the first records in step (i) correspond to a record of candidate router maintained at the watching means for determining activation and/or deactivation of candidate routers;
(k) monitoring router activity at least locally within the network;
(l) updating the one or more candidate devices regarding which of the candidate devices are to be active and which are to be inactive; and
(m) updating the record of candidate router maintained at the watching means.

8. A communication network including one or more candidate devices operable to function as routers according to the method of claim 1.

9. A candidate device operable as a router according to the method of claim 1.

10. A router monitoring device including watching means operable according to the method of claim 7.
